(19) United States
(12) Patent Application Publication
(10) Pub. No.: US 2003/0003336 A1
(43) Pub. Date: Jan. 2, 2003

(54) Method and apparatus for adjusting the temperature of a fuel cell by facilitating methanol crossover and combustion

(76) Inventors: Kevin Michael Colbow, North Vancouver (CA); Jiujun Zhang, Richmond (CA); David Pentreath Wilkinson, North Vancouver (CA); Jean St-Pierre, Vancouver (CA)

Correspondence Address: Robert W. Fieseler, McAndrews, Held & Malloy, Ltd., 34th Floor, 500 West Madison Street, Chicago, IL, 60661, US

(21) Appl. No.: 09/894,707

(22) Filed: Jun. 28, 2001

(51) Int. Cl. H01M 8/04

(52) U.S. Cl. 429/24; 429/13; 429/30

(57) ABSTRACT

A method is provided for adjusting the temperature of a solid polymer electrolyte fuel cell, such as a direct methanol fuel cell or PEM fuel cell. A method is also provided for starting a solid polymer electrolyte fuel cell. A solid polymer electrolyte fuel cell apparatus is further provided. In the present methods and apparatus, the temperature of a fuel cell is increased by providing a fuel stream containing methanol to the fuel cell anode and facilitating methanol crossover and combustion. The methanol concentration or methanol pressure can be adjusted in response to a measured parameter indicative of the fuel cell temperature.

### FIELD OF THE INVENTION

The present invention relates to a method and apparatus for adjusting the temperature of a solid polymer electrolyte fuel cell by providing a fuel stream containing methanol to the fuel cell anode and facilitating methanol crossover and combustion. The method can be used to increase temperature, for example, during start-up when the temperature of the fuel cell is below a preferred operating temperature range or to maintain the temperature within a preferred operating temperature range after start-up of the fuel cell. The present invention also relates to a method and apparatus wherein methanol combustion is facilitated in a direct methanol fuel cell or a proton exchange membrane fuel cell.

### BACKGROUND OF THE INVENTION

Electrochemical fuel cells convert fuel and oxidant to electricity and reaction product. Solid polymer electrochemical fuel cells generally employ a membrane electrode assembly (“MEA”) comprising a solid polymer electrolyte or ion exchange membrane disposed between two fluid diffusion layers formed of electrically conductive material. The fluid diffusion layer has a porous structure across at least a portion of its surface area, which renders it permeable to fluid reactants and products in the fuel cell. The electrochemically active region of the MEA also includes a quantity of electrocatalyst, typically disposed in a layer at each membrane/fluid diffusion layer interface, to induce the desired electrochemical reaction in the fuel cell. The fluid diffusion layer and electrocatalyst form an electrode (specifically, the anode and the cathode). The electrodes thus formed are electrically coupled to provide a path for conducting electrons between the electrodes through an external load.

A fuel inlet stream is directed to the anode side of the fuel cell. At the anode, the fluid fuel stream moves through the porous portion of the anode fluid diffusion layer and is oxidized at the anode electrocatalyst. An oxidant inlet stream is directed to the cathode side of the fuel cell. At the cathode, the fluid oxidant stream moves through the porous portion of the cathode fluid diffusion layer and is reduced at the cathode electrocatalyst. A fuel outlet stream and an oxidant outlet stream exit from the anode and cathode, respectively.

In electrochemical fuel cells, the MEA is typically interposed between two separator plates or fluid flow field plates (anode and cathode plates). The plates typically act as current collectors, provide support to the MEA, and prevent mixing of the fuel and oxidant streams in adjacent fuel cells, thus, they are typically electrically conductive and substantially fluid impermeable. Fluid flow field plates typically have channels, grooves or passages formed therein to provide means for access of the fuel and oxidant streams to the surfaces of the porous anode and cathode layers, respectively.

Two or more fuel cells can be connected together, generally in series but sometimes in parallel, to increase the overall power output of the assembly. In series arrangements, one side of a given plate serves as an anode plate for one cell and the other side of the plate can serve as the cathode plate for the adjacent cell. Such plates are sometimes referred to as bipolar plates. Such a series arrangement of fuel cells is referred to as a fuel cell stack. The stack typically includes manifolds and inlet ports for directing the fuel and the oxidant to the anode and cathode fluid distribution layers, respectively. Significant heat can be produced within an operating stack, particularly those intended for high power applications, and thus the stack can include a manifold and inlet port for directing a coolant fluid to interior channels within the stack. The coolant fluid is employed to maintain the fuel cell temperature within a preferred operating temperature range. The stack also generally includes exhaust manifolds and outlet ports for expelling the unreacted fuel and oxidant streams, as well as an exhaust manifold and outlet port for the coolant fluid exiting the stack.

In fuel cells employing hydrogen as the fuel and oxygen-containing air (or substantially pure oxygen) as the oxidant, the catalyzed reaction at the anode produces hydrogen cations (protons) from the fuel supply. The ion exchange membrane facilitates the migration of protons from the anode to the cathode. In addition to conducting protons, the membrane isolates the hydrogen-containing fuel stream from the oxygen-containing oxidant stream. At the cathode electrocatalyst layer, oxygen reacts with the protons that have crossed the membrane to form water as the reaction product. The anode and cathode reactions in hydrogen/oxygen fuel cells are shown in the following equations:

Anode reaction: H₂→2H⁺+2e⁻

Cathode reaction: ½O₂+2H⁺+2e⁻→H₂O

Such fuel cells are typically referred to as proton exchange membrane (“PEM”) fuel cells.

In electrochemical fuel cells employing methanol as the fuel supplied to the anode and an oxygen-containing stream, such as air (or substantially pure oxygen) as the oxidant supplied to the cathode, the methanol is oxidized at the anode to produce protons and carbon dioxide. Typically, the methanol is supplied to the anode as an aqueous solution or as a vapor. The protons migrate through the ion exchange membrane from the anode to the cathode, and at the cathode electrocatalyst layer, oxygen reacts with the protons to form water. The anode and cathode reactions in this type of direct methanol fuel cell are shown in the following equations:

Anode reaction: CH₃OH+H₂O→CO₂+6H⁺+6e⁻

Cathode reaction: 3/2O₂+6H⁺+6e⁻→3H₂O

Such fuel cells are typically referred to as direct methanol fuel cells (“DMFCs”). A direct methanol fuel cell typically has an electrocatalyst selected for operation on a methanol-containing fuel reactant stream. Many electrode structures presently used in direct methanol fuel cells were originally developed for hydrogen/oxygen fuel cells. The anode electrocatalyst which promotes the oxidation of methanol to produce protons is typically provided as a thin layer adjacent to the ion-exchange membrane (see U.S. Pat. Nos. 5,132,193 and 5,409,785 and European Patent Publication No. 0090358, which are incorporated herein by reference in their entireties). The anode electrocatalyst layer is typically applied as a coating to one major surface of a sheet of porous, electrically conductive sheet material or to one surface of the ion-exchange membrane. This provides a limited reaction zone in which the methanol can be oxidized before contacting the membrane electrolyte. Liquid feed direct methanol fuel cell stacks typically do not include separate coolant channels, since the liquid aqueous methanol fuel stream can act as a coolant.

Direct methanol fuel cells are discussed in “Design and Operation of an Electrochemical Methanol Concentration Sensor for Direct Methanol Fuel Cell Systems,” by S. R. Narayanan et al., Electrochemical and Solid-State Letters, 3(3) 117-120 (2000). Narayanan et al. discloses a direct methanol fuel cell system comprising a methanol concentration sensor in the fuel circulation loop and a fuel injection device. The direct methanol fuel cell system further comprises a cold-start heater in the fuel inlet stream and a radiator in the fuel outlet stream. In this system, a fuel stream containing methanol is circulated in a loop, and pure methanol is added to this fuel circulation loop to maintain the required methanol concentration. An automated feedback system for concentration management and control based on the sensor and fuel injection device is described. Narayanan et al. states that the methanol concentration in the fuel circulation loop determines the electrical performance and efficiency of the system. Narayanan et al. states that high methanol concentration allows for higher power densities but also results in increased fuel loss due to crossover of the fuel from the anode to the cathode, which results in a low fuel cell efficiency. The power density and the rate of fuel crossover at a chosen cell voltage are stated to be strong functions of the operating temperature. Hence, the methanol concentrations for obtaining the highest efficiency vary with the operating stack temperature. The methanol concentration can be specified differently for the start-up procedure, transient performance requirements, idling mode, and steady state operation. As a result, accurate monitoring and control of methanol in the fuel concentration is required.

In the DMFC system of Narayanan et al., the temperature of the fuel cell system is controlled in large part by devices in the circulating fuel stream (for example, radiator with bypass and cold-start heater). The automated feedback system in the DMFC system employed the temperature-compensated molarity as the input to a decision-making loop that controlled the methanol feed pump. In an experiment to demonstrate concentration control, the concentration of methanol in the fuel feed was maintained at about 0.5M over 30 minutes. In another experiment, the methanol concentration was maintained at 0.15M±0.02M during a 70 hour test. The experiments in Narayanan et al. do not disclose variation of methanol concentration in response to a monitored parameter, only maintenance of the methanol concentration. The sensor in Narayanan et al. monitors methanol concentration of the fuel in the fuel circulation loop, not fuel cell temperature or performance.

It is known that methanol crossover is detrimental to steady-state performance of liquid feed fuel cells. “Methanol crossover” refers to methanol at a first electrode of the fuel cell passing through the electrolyte to the second electrode, instead of reacting at the first electrode. In solid polymer electrolyte fuel cells, the ion exchange membrane may be permeable to one or more of the reactants. For example, ion exchange membranes typically employed in solid polymer electrolyte fuel cells are permeable to methanol, thus methanol which contacts the membrane prior to participating in the oxidation reaction can cross over to the cathode. Diffusion of methanol fuel from the anode to the cathode leads to a reduction in fuel utilization efficiency and to performance losses (see, for example, S. Surampudi et al., Journal of Power Sources, vol. 47, 377-385 (1994) and C. Pu et al., Journal of the Electrochemical Society, vol. 142, L119-120 (1995)). Fuel cell performance may be expressed as the voltage output from the cell at a given current density or vice versa; a higher voltage at a given current density, or a higher current density at a given voltage, indicates better performance.

International Publication No. WO 97/50140 describes a direct methanol fuel cell system having an evaporator upstream of the fuel cell so that the fuel is present at the anode in gaseous form. The system also employs a heat exchanger in the fuel outlet stream. It is stated that a general problem with the implementation of the DMFC remains the diffusion of fuel methanol through the electrolyte to the cathode, which results in loss of fuel and decrease of cell voltage. The DMFC system disclosed therein is supplied to the anode in gaseous form in an attempt to reduce methanol crossover and to optimize efficiency. The fuel, which is mainly a mixture of methanol and water, possibly with an inert gas added, is of variable composition. The mixture is adjustable in dependence on the load.

Fuel utilization efficiency losses arise from methanol diffusion away from the anode because some of the methanol which would otherwise participate in the oxidation reaction at the anode and supply electrons to do work through the external circuit is lost. Methanol arriving at the cathode is electrochemically or chemically oxidized at the cathode electrocatalyst, consuming oxidant, as follows:

CH₃OH+3/2O₂→CO₂+2H₂O

Methanol diffusion to the cathode has been thought to lead to a decrease in fuel cell performance. The oxidation of methanol at the cathode reduces the concentration of oxygen at the electrocatalyst and may affect access of the oxidant to the electrocatalyst (mass transport issues). Further, depending upon the nature and potential of the cathode electrocatalyst and the oxidant supply, the electrocatalyst may be poisoned by methanol oxidation products, or sintered by the methanol oxidation reaction. Several efforts have been made toward reducing methanol crossover in a direct methanol fuel cell.

For conventional direct methanol fuel cells, the methanol concentration in the fuel stream is typically maintained at a selected concentration falling within the range of 0.4M to 2.5M. This concentration range is generally selected for purposes of maximizing efficiency which involves a compromise between increasing cell performance, which increases with methanol concentration, and decreasing methanol crossover, which also increases with methanol concentration. These concentrations of methanol are typically not sufficient to substantially lower the freezing point of aqueous solutions. For example, a methanol concentration greater than 10M is required to obtain a freezing point below −25° C., which is a potential target temperature tolerance for fuel cells to be used in transportation applications.

In some applications, fuel cell systems operate almost continuously (for example, certain stationary power applications). However, in other applications, fuel cell systems are subjected to frequent start and stop cycles and to prolonged storage periods in between (for example, portable or traction power applications). Further, in colder climates, such fuel cell systems are frequently subjected to temperatures below freezing. It is desirable to be able to start-up such systems and bring them up to normal operating temperature in a timely way and to maintain the temperature within a desirable range during operation.

A number of approaches have been developed to enable or facilitate the cold temperature start-up of proton exchange membrane fuel cell stacks employing hydrogen as the fuel. These prior approaches have less applicability to direct methanol fuel cells. For example, combustion of fuel and oxidant in coolant flow fields is not applicable if a direct methanol fuel cell stack does not comprise separate coolant flow fields.

The stack operating conditions for direct methanol fuel cell stacks geared toward transportation applications typically comprise a pressure greater than ambient, such as 300 kPa, as well as an operating temperature greater than ambient such as approximately 110° C. The fuel stream and oxidant stream are typically supplied to the fuel cells at elevated temperature and pressure. Temperature control of such stacks typically involves adjusting the temperature of the inlet fuel stream and/or the outlet fuel stream via the use of coolers, heat exchangers, evaporators, or the like in a circulating fuel stream. Direct methanol fuel cells stacks geared toward compact power generation applications have tended toward operating conditions at near ambient conditions.

### SUMMARY OF THE INVENTION

In certain solid polymer electrolyte fuel cell systems that employ methanol containing fuel streams, it can be advantageous to use the fuel stream less efficiently with regards to the generation of electrical power in order to increase the temperature of the fuel cell. This is accomplished by using greater methanol concentrations or pressures in the fuel stream than would otherwise be selected for maximum operating efficiency, thereby resulting in greater methanol crossover (across the membrane electrolyte). The additional methanol crossing over the membrane reacts at the cathode and generates additional heat. This additional heat is used in the operation of the present fuel cell systems.

In certain of these systems, fuel cell temperature is maintained by adjusting the methanol concentration or pressure in the fuel stream in accordance with fuel cell temperature. Thus, the fuel cell system can be heated without evaporators or heaters and its temperature controlled without having to control the output temperature of heat exchangers, coolers, or the like in a recirculation line during normal operation.

Alternatively, during start-up, the fuel cell temperature is expeditiously increased to its normal operating temperature by increasing the methanol concentration or pressure significantly during the starting period. In this way, fuel cell temperature can be increased without special heaters for start-up.

### BRIEF DESCRIPTION OF THE DRAWINGS

FIG. 1 is a schematic diagram of a direct methanol fuel cell stack system in which methanol concentration in the fuel inlet stream is adjusted in response to fuel cell temperature.

FIG. 2 shows polarization and power density curves for a ten-cell DMFC stack employing fuel streams with two different methanol concentrations.

FIG. 3 shows the temperature versus time plot of a DMFC in an open circuit condition during a starting period.

FIG. 4 shows polarization curves at various starting temperatures for a DMFC supplied with a 9.8M methanol fuel stream.

### DETAILED DESCRIPTION OF PREFERRED EMBODIMENT(S)

A method of controlling the operating temperature of a solid polymer electrolyte fuel cell is provided. The method comprises the steps of supplying an oxidant inlet stream to the cathode of the fuel cell; supplying a fuel inlet stream comprising methanol to the anode of the fuel cell, and measuring a parameter indicative of fuel cell temperature.

The method also comprises the step of adjusting a fuel inlet stream characteristic, such as methanol concentration or methanol pressure, in response to the measured parameter and thereby adjusting methanol crossover from the anode to the cathode. The methanol concentration or methanol pressure is increased so as to increase methanol crossover in order to increase fuel cell temperature. Alternatively, the methanol concentration or methanol pressure is decreased so as to reduce methanol crossover in order to reduce fuel cell temperature.

The methanol concentration or methanol pressure may be adjusted in response to the measured temperature of the fuel cell, or in response to the measured temperature of an outlet stream from the fuel cell. Preferably, the fuel cell operates at a temperature of about 70° C. or higher since fuel cell performance generally increases with operating temperature. When the present method is used in a direct methanol fuel cell (DMFC), the DMFC will exhaust a fuel outlet stream and an oxidant outlet stream.

The method can comprise the step of maintaining the methanol concentration of the fuel inlet stream at about 1.5M or higher for an extended period, for example the entire operating time of the fuel cell. It may be advantageous to employ a fuel cell construction that facilitates methanol crossover (for example, by employing a more methanol permeable membrane electrolyte). Further, it may be advantageous to employ a construction in which methanol combustion at the cathode is enhanced (for example, by employing a cathode catalyst adapted for promoting methanol combustion).

As another aspect, a method is provided for starting a fuel cell from a starting temperature below the normal operating temperature of the fuel cell. The starting temperature can be at or below the freezing point of water. Over a starting period, the temperature of the fuel cell rises to the normal operating temperature.

The normal operating temperature for a given fuel cell refers to temperature during normal or steady-state operation. The normal operating temperature is not a specific, pre-set and/or unvarying value, since it may vary based on the reactants and parameters of one's choosing, but it can be determined simply by measuring it at any given time during operation at the chosen reactants and parameters.

The method comprises supplying an oxidant inlet stream to the cathode of the fuel cell; supplying a fuel inlet stream comprising methanol to the anode of the fuel cell, wherein the fuel inlet stream has a starting methanol concentration or a starting methanol pressure during the starting period, and adjusting the methanol concentration or methanol pressure to a normal operating methanol concentration or normal operating methanol pressure in the fuel inlet stream after the starting period, in which the normal operating methanol concentration or normal operating methanol pressure is less than the starting methanol concentration or starting methanol pressure. In embodiments in which the concentration is adjusted, the normal operating methanol concentration can be from about 0.5M to about 1.5M. The starting methanol concentration can be about 1.5M or higher.

The methanol concentration or methanol pressure can be lowered in response to a measured parameter of the fuel cell. For example, the methanol concentration or methanol pressure can be lowered in response to the temperature of the fuel cell. As another example, the methanol concentration or methanol pressure can be lowered in response to the temperature of an outlet stream from the fuel cell.

In the present methods, the fuel cell comprises an anode, a cathode, and a solid polymer electrolyte between the anode and the cathode. The fuel cell can be a direct methanol fuel cell or a proton exchange membrane fuel cell.

In the present methods, to provide further heating if desired, methanol can be added to the oxidant inlet stream in response to the measured parameter and/or an oxidant can be added to the fuel inlet stream in response to the measured parameter.

As another aspect, a solid polymer electrolyte fuel cell system is provided. The system comprises a solid polymer electrolyte fuel cell, an oxidant supply system for directing an oxidant inlet stream to the cathode of the fuel cell, a fuel supply system for directing a fuel inlet stream comprising methanol to the anode of the fuel cell, a sensor for measuring a parameter indicative of fuel cell temperature, and a control system for controlling the temperature of the fuel cell in which the control system adjusts the methanol concentration or methanol pressure in the fuel inlet stream in responsive to the measured parameter.

The fuel supply system may receive a fuel outlet stream from the fuel cell stack and recirculate a portion of the fuel outlet stream into the fuel inlet stream without heating the recycled portion. The fuel supply system does not need a heating element then to heat the fuel inlet stream outside of the fuel cell stack. In systems comprising a gas separator, condenser, cooler or the like at the fuel outlet, the temperature of the gas-separated, condensed, or cooled fuel outlet stream need not be controlled.

In the present methods and apparatus, heat is provided from the reaction of methanol in the electrochemical reaction that is the basis of fuel cell operation. That is, the oxidation reaction at the anode and the reduction reaction at the cathode yield an overall reaction, which is exothermic and produces electrical energy and heat. However, heat can also be generated by the combustion of methanol due to methanol crossover. This additional heat is evidenced by a further increase in the fuel and oxidant stream outlet temperatures.

The electrochemical and combustion heating processes contribute to a self-heating phenomenon within the electrochemical fuel cell stack. The present methods and apparatus employ the self-heating phenomenon for starting a fuel cell or for controlling the temperature of a fuel cell. The methods are suitable for use for direct methanol fuel cells or for PEM fuel cells operating on a gaseous fuel stream-containing methanol reformate.

In a direct methanol fuel cell, the crossover of methanol across the membrane from the anode to the cathode is controlled by varying the methanol concentration or pressure in the fuel inlet stream. The choice and thickness of the membrane electrolyte, the design of the anode electrode structure, and other construction factors (for example, flow field design) along with the fuel cell operating conditions (for example, temperature and current density) will influence the methanol crossover rate. Thus, the methanol concentration and/or methanol pressure required to obtain a given crossover rate depends on many factors. However, in the present methods and apparatus, the crossover is adjusted by varying the methanol concentration or methanol pressure to an amount that exceeds that conventionally selected for obtaining optimum fuel cell efficiency.

After crossing over the membrane, the methanol will react with oxygen in the oxidant stream on the cathode in a combustion reaction. The use of fuel streams having high concentrations or pressures of methanol facilitates methanol crossover. Methanol that crosses over can be combusted on the cathode catalyst (on the cathode side of the fuel cell), which ultimately creates more heat and thereby reduces fuel cell start-up time. A high methanol concentration or pressure also can create oxidant starvation conditions, which also increase the fuel cell heating rate at cold start-up. A high methanol concentration can be utilized to delay fuel circulation on start-up which would remove desirable heat from the fuel cell; in other words, if a highly concentrated methanol solution is provided in the fuel pathways of the fuel cell, it can remain in those pathways for a longer period of time, without circulating the fuel stream through the fuel cell.

In the present methods, additional heat is generated by directly adding methanol to the oxidant stream and/or by directly adding oxidant to the fuel stream. This and other techniques can also be employed in combination. For example, methanol can be supplied to both oxidant and fuel flow fields and combusted therein until the temperature of the fuel cell has raised above the freezing point of water. At that time, a load can be applied, thus increasing the heat being generated within the fuel cell. This has the advantage of limiting freeze-related damages to the electrocatalysts, membranes, substrates and bipolar plates.

In environments where the ambient temperature is below the operating temperature of the fuel cell, in particular below 0° C., it is desirable to employ a methanol concentration of about 10M or higher so that the freezing point of the fuel stream is sufficiently lowered. By employing methanol concentrations greater than about 8M at start-up or during storage, a freezing point of −25° C. or lower can be obtained.

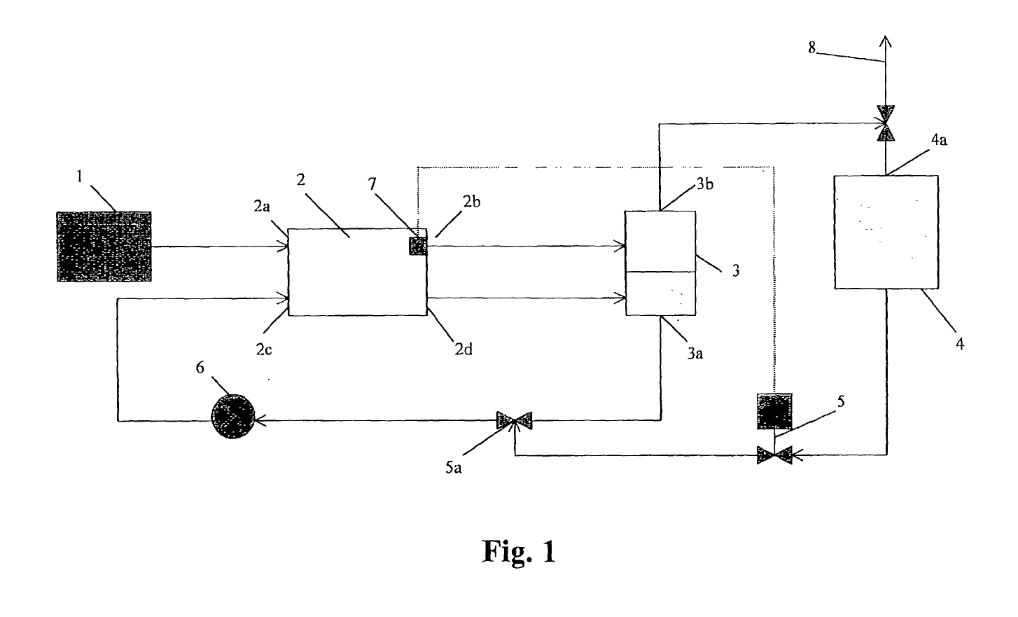

FIG. 1 discloses a schematic of a direct methanol fuel cell system in which methanol concentration in the fuel inlet stream is adjusted in response to fuel cell temperature. In FIG. 1, direct methanol fuel cell stack 2 is a relatively small unit designed for compact power applications and operates under ambient conditions. Air pump 1 supplies an ambient temperature air stream to fuel cell stack 2 at oxidant inlet 2a. The air stream is then exhausted at oxidant outlet 2b and directed to gas/liquid separator 3. Fuel cell stack 2 is supplied at fuel inlet 2c with a liquid fuel inlet stream comprising a mixture of methanol and water from fuel pump 6. The fuel inlet stream has a methanol concentration which is variable. The fuel stream is exhausted at fuel outlet 2d and directed to gas/separator 3. Gas/liquid separator 3 separates unreacted or by-product liquid water and methanol from the air and fuel outlet streams. The liquid water and methanol mixture is directed from liquid outlet 3a and circulated back into the fuel inlet stream. Depleted air and carbon dioxide by-product gases are directed from gas outlet 3b and used to pressurize liquid methanol reservoir 4 at pressurizing inlet 4a. Excess gases are exhausted to the atmosphere from line 8.

The fuel inlet stream comprises a mixture of liquid water and methanol from gas/liquid separator 3 and also liquid methanol from reservoir 4. The methanol concentration in the fuel inlet stream is adjusted and varied by the action of controller/injector valve 5, which injects a greater or lesser amount of methanol from fuel reservoir 4 into the fuel inlet stream at 5a. The injector valve can be manually controlled or automatically controlled in response to some measured parameter indicative of the temperature of fuel cell stack 2. As shown in FIG. 1, thermocouple 7 located on fuel cell stack 2 is used to measure the fuel cell stack temperature. The dotted line in FIG. 1 indicates a path of communication or transmittal of information from thermocouple 7 and controller/injector valve 5. As shown in FIG. 1, controller/injector valve 5 additionally comprises a controller which determines whether to inject more or less methanol into the fuel inlet stream in response to the temperature of fuel cell stack 2.

To maintain fuel cell stack within a normal operating temperature range defined by predetermined lower and upper values, more methanol is injected into the fuel inlet stream when the stack temperature is below the lower predetermined value and less methanol is injected when the stack temperature is above the upper predetermined value. When starting up the direct methanol fuel cell system in FIG. 1 from ambient temperature, controller/injector valve 5 injects sufficient methanol such that the starting concentration of methanol in the fuel inlet stream is higher than that when the stack is operating within its normal operating temperature range. The higher concentration results in greater methanol crossover for self-heating and thus reduces the time required to warm up fuel cell stack 2. When shutting down the system, controller/injector valve 5 can also be used to adjust the methanol concentration in the fuel inlet stream to the higher starting methanol concentration or other methanol concentration to prevent freezing in the stack or circulating fuel stream.

An alternative embodiment (not shown) comprises a PEM fuel cell stack instead of a direct methanol fuel cell stack. Here, the fuel inlet stream comprises reformate supplied by a reformer. Methanol is typically present in small amounts in gaseous form in the reformate but the partial pressure of the methanol can be adjusted by suitably varying the operation of the reformer. As discussed above, varying the methanol pressure in the fuel inlet stream can be particularly useful during start-up of the stack but also is an option for purposes of controlling the operating temperature of the stack.

### EXAMPLES

Several direct methanol fuel cells were tested to investigate certain characteristics important to operating an ambient temperature DMFC where start-up and temperature control during normal operation involve varying the methanol concentration in the fuel inlet stream.

In all cases, aqueous methanol solutions were prepared using analytical grade methanol and deionized water. Low pressure air was used as the oxidant.

A DMFC stack was assembled from ten fuel cells comprising membrane electrode assemblies in which the cathodes were prepared from TGP-H-060 (product of Toray) with 6% by weight PTFE binder, a 0.6 mg/cm² carbon base layer and a loading of 3.5 mg/cm² platinum black catalyst. The anodes were prepared from TGP-H-090 and contained 4 mg/cm² of Johnson Matthey Platinum/Ruthenium Black catalyst. The proton conducting membrane was NAFION™ 115. The electrochemically active area for each membrane electrode assembly was 30 cm².

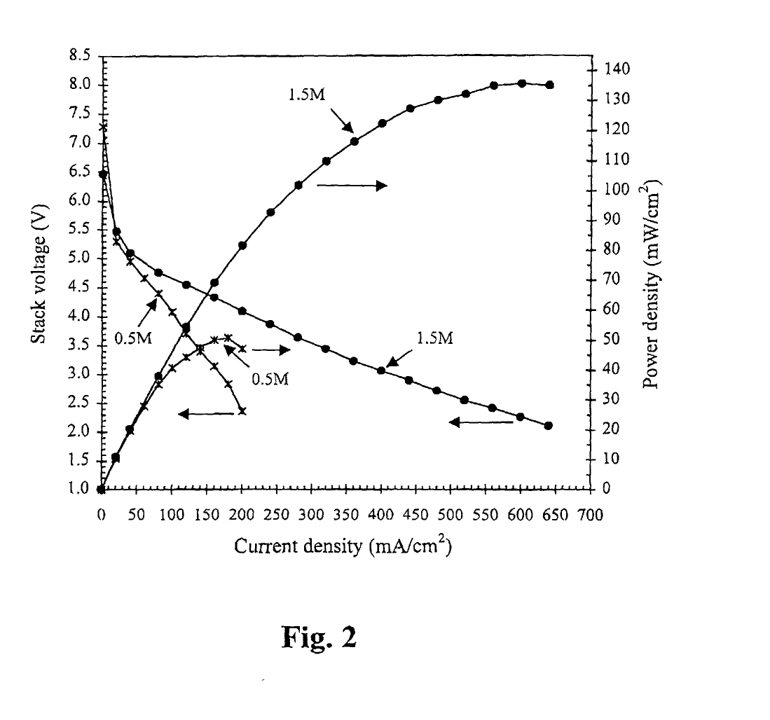

The stack was operated in an ambient environment and was supplied with reactants, without recirculation, at ambient temperature (about 25° C.). FIG. 2 shows polarization (in other words, voltage versus current density) and power density curves for this DMFC stack employing fuel streams with two different methanol concentrations in the fuel inlet stream. When operated using a 0.5M aqueous methanol solution as the fuel stream, the stack temperature was about 30° C. as measured on the stack surface and the polarization and power density results were comparatively low. When using a 1.5M aqueous methanol solution as a fuel stream, the stack temperature was at about 70 to 80° C. (a more desirable operating temperature for performance purposes), and the polarization and power density results were significantly improved. This improvement is mainly attributed to the higher operating temperature arising from self-heating, which in turn is attributed to methanol crossover and combustion. (In FIG. 2, the x-axis shows current density expressed in milliamperes per square centimeter. The left y-axis expresses stack voltage in volts and the right y-axis expresses power density in milliwatts per square centimeter.) In ambient DMFCs therefore, these results indicate that temperature control in a desirable operating temperature range might be effected simply by adjusting the methanol concentration while obtaining satisfactory fuel cell performance.

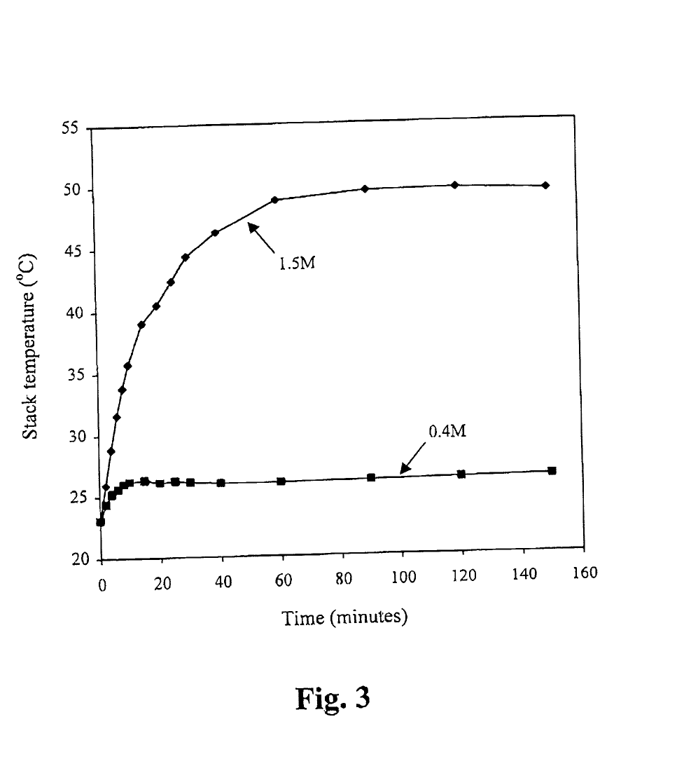

Another similar but larger 10-cell DMFC stack was assembled as above (the electrochemically active area for each MEA was now about 120 cm²). Again, the stack was operated in an ambient environment and supplied with reactants at ambient temperature. Here, the stack was kept in an open circuit condition while being supplied with two different methanol concentrations in the fuel inlet stream. FIG. 3 shows the stack temperature versus time when using a 0.4M methanol fuel stream and when using a 1.5M methanol fuel stream. Since the stack was at an open circuit condition, the temperature increase above ambient in each case is solely a result of methanol crossover and combustion. Using a 1.5M methanol solution, the stack self-heated up to 50° C. as a result of methanol crossover alone. This example shows that methanol crossover alone can adequately heat the stack for purposes of temperature control and for start-up purposes from room temperature using a fuel whose methanol concentration also provides for satisfactory fuel cell performance.

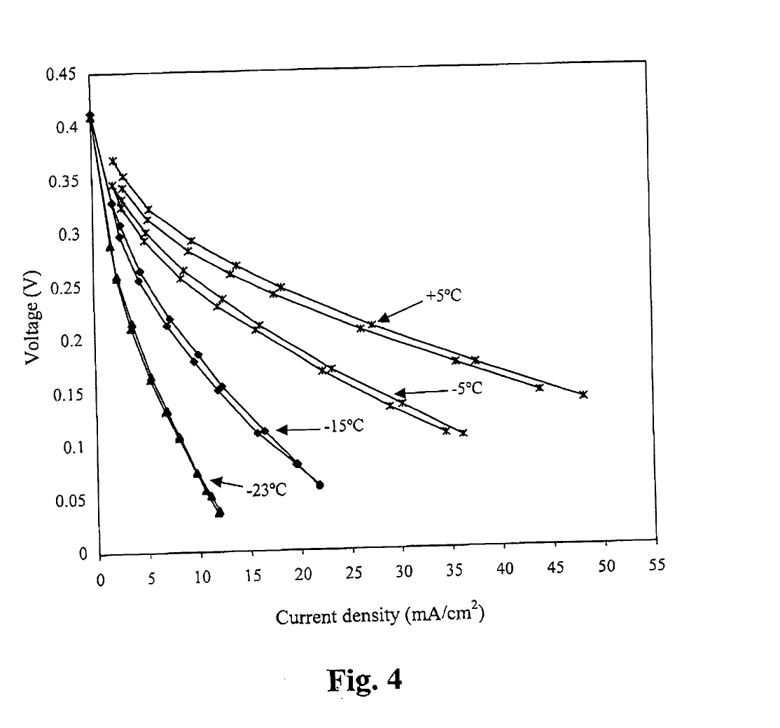

A similar but smaller, single-cell DMFC was assembled (the electrochemically active area for the MEA was now about 6 cm²) as above. Again, the stack was operated in an ambient pressure environment. Here, the cell was operated and maintained at various starting temperatures well below room temperature (in other words, the cell was not allowed to heat up). The reactants were also supplied at the same temperature as the cell and a highly concentrated 9.8M aqueous methanol solution was used as the fuel stream. FIG. 4 shows the polarization curves obtained at temperatures of +5, −5, −15, and −23° C. (FIG. 4 shows two curves at each temperature, one obtained for voltage data while decreasing the current density and one obtained for voltage data while increasing the current density. FIG. 4 shows no significant hysteresis in the curves.) The cell performance is relatively quite low using these temperatures and this highly concentrated fuel solution. Nonetheless, the cell is operative and would have modest power capability during a warming up period at these temperatures. Thus, the cell is capable of tolerating a highly concentrated fuel solution during a starting period. The highly concentrated fuel solution can be expected to substantially enhance methanol crossover and thus reduce warm up times.

While particular elements, embodiments, and applications of the present invention have been shown and described, it will be understood, of course, that the invention is not limited thereto since modifications may be made by those skilled in the art, particularly in light of the foregoing teachings. It is therefore contemplated that the appended claims cover such modifications as incorporate those features, which come within the scope of the invention.

What is claimed is:

1. A method of controlling the temperature of a solid polymer electrolyte fuel cell, the fuel cell comprising an anode, a cathode, and a solid polymer electrolyte between the anode and the cathode, the method comprising the steps of:
supplying an oxidant inlet stream to the cathode of the fuel cell;
supplying a fuel inlet stream comprising methanol to the anode of the fuel cell;
measuring a parameter indicative of fuel cell temperature; and
adjusting a fuel inlet stream characteristic in response to the measured parameter wherein the fuel inlet stream characteristic is methanol concentration or methanol pressure in the fuel inlet stream.

2. The method of claim 1 wherein the fuel inlet stream characteristic is increased when the fuel cell temperature is below a lower predetermined value.

3. The method of claim 2 wherein increasing the fuel inlet stream characteristic increases the methanol crossover from the anode to the cathode.

4. The method claim of 3 further comprising the step of maintaining the methanol concentration of the fuel inlet stream at about 1.5M or higher for an extended period of operation.

5. The method of claim 1 wherein the fuel inlet stream is supplied unheated.

6. The method of claim 5 wherein the fuel inlet stream is supplied at ambient temperature.

7. The method of claim 1 wherein the fuel inlet stream characteristic is decreased when the fuel cell temperature is above an upper predetermined value.

8. The method of claim 1 wherein the fuel cell is a direct methanol fuel cell and the fuel inlet stream comprises methanol and water.

9. The method of claim 8 wherein the direct methanol fuel cell is operated at a temperature in the range of from about 70° C. to about 90° C.

10. The method of claim 1 wherein the fuel inlet stream comprises gaseous hydrogen and methanol supplied from a reformer.

11. The method of claim 10 wherein the fuel inlet stream characteristic is adjusted by varying the operation of the reformer.

12. The method claim of 1 wherein the measured parameter is the temperature of the fuel cell.

13. The method claim of 1 wherein the measured parameter is the temperature of a fuel outlet stream or an oxidant outlet stream from the fuel cell.

14. A method of starting a solid polymer electrolyte fuel cell from a starting temperature below the normal operating temperature of the fuel cell, the temperature of the fuel cell rising to the normal operating temperature over a starting period, the fuel cell comprising an anode, a cathode, and a solid polymer electrolyte between the anode and the cathode, the method comprising:
supplying an oxidant inlet stream to the cathode of the fuel cell;
supplying a fuel inlet stream comprising methanol to the anode of the fuel cell, wherein the fuel inlet stream has a starting fuel inlet stream characteristic during the starting period, wherein the characteristic is methanol concentration or the methanol pressure in the fuel inlet stream; and
adjusting the fuel inlet stream characteristic to a normal operating fuel inlet stream characteristic after the starting period wherein the normal operating fuel inlet stream characteristic is less than the starting fuel inlet stream characteristic.

15. The method of claim 14 wherein methanol crossover from the anode to the cathode during the starting period is greater than methanol crossover after the starting period.

16. The method of claim 14 wherein the fuel inlet stream is supplied unheated.

17. The method of claim 16 wherein the fuel inlet stream is supplied at ambient temperature.

18. The method of claim 14 wherein the fuel cell is a direct methanol fuel cell and the fuel inlet stream comprises methanol and water.

19. The method of claim 14 wherein the fuel inlet stream comprises gaseous hydrogen and methanol supplied from a reformer.

20. The method of claim 19 wherein the fuel inlet stream characteristic is adjusted by varying the operation of the reformer.

21. The method claim of 14 wherein the fuel inlet stream characteristic is adjusted in response to the temperature of the fuel cell.

22. The method of claim 14 wherein the starting temperature is at or below the freezing point of water.

23. The method of claim 14 wherein the fuel inlet stream characteristic is the methanol concentration and the normal operating methanol concentration is from about 0.5M to about 1.5M.

24. The method of claim 14 wherein the fuel inlet stream characteristic is the methanol concentration and the starting methanol concentration is about 1.5M or higher.

25. A solid polymer electrolyte fuel cell system comprising:
a solid polymer electrolyte fuel cell, the fuel cell comprising an anode, a cathode, and a solid polymer electrolyte between the anode and the cathode;
an oxidant supply system for directing an oxidant inlet stream to the cathode of the fuel cell;
a fuel supply system for directing a fuel inlet stream comprising methanol to the anode of the fuel cell,
a sensor for measuring a parameter indicative of fuel cell temperature; and
a control system for controlling the temperature of the fuel cell, wherein the control system adjusts the methanol concentration or the methanol pressure in the fuel inlet stream in response to the parameter measured by the sensor.

26. The fuel cell system of claim 25 wherein the fuel cell is a direct methanol fuel cell.

27. The fuel cell system of claim 26 wherein the fuel inlet stream is a liquid mixture of methanol and water.

28. The fuel cell system of claim 25 wherein the fuel supply system comprises a reformer and the fuel inlet stream is reformate comprising gaseous hydrogen and methanol.

29. The fuel cell system of claim 25 wherein the fuel inlet stream directed to the anode of the fuel cell is unheated.

30. The fuel cell system of claim 29 wherein the fuel supply system receives a fuel outlet stream from the fuel cell stack and recirculates at least a portion of the fuel outlet stream into the fuel inlet stream without heating the recirculated portion.
